(19) United States
(12) Patent Application Publication
(10) Pub. No.: US 2022/0158533 A1
(43) Pub. Date: May 19, 2022

(54) Concentric Nested Rotor Power Converter and Charge Replenisher

(71) Applicant: William G. Lipford, Brooklyn, NY (US)

(72) Inventor: William G. Lipford, Brooklyn, NY (US)

(21) Appl. No.: 17/526,737

(22) Filed: Nov. 15, 2021

Related U.S. Application Data
(60) Provisional application No. 63/113,591, filed on Nov. 13, 2020.

(51) Int. Cl. H02K 47/20

(52) U.S. Cl. CPC H02K 47/20

(57) ABSTRACT

The power converter is a device that aims to provide an improved design for a power generator using multiple independent rotor and stator assemblies. To accomplish this, the device includes a drive motor that runs a generator that has dual magnetic rotors, wherein the whole assembly is mounted on a single stabilizing post that acts as the stator coil for the drive motor. Preferably, the generator comprises two magnetic rotors, one of which has an in-runner configuration, and the other has an out-runner configuration. The two magnetic rotors, arranged in the two different configurations, generate power that is much greater that the input energy provided to run the top drive motor. Thus, the device includes an assembly formed of three magnetic rotors, wherein a small amount of power provided to a driving motor generates a larger magnitude of power, that could be recovered and saved as usable energy.

The current application claims a priority to the U.S. provisional patent application Ser. No. 63/113,591 filed on Nov. 13, 2020. The current application is filed on Nov. 15, 2021 while Nov. 13, 2021 was on a weekend.

### FIELD OF THE INVENTION

The present invention relates generally to an energy converter. More specifically, the present invention relates to a generator with multiple independent rotor and stator assemblies.

### BACKGROUND OF THE INVENTION

The world uses approximately 320 billion kilowatt-hours of energy a day. Finding methods and sources for generating power has been a constant challenge in today's world. Permanent magnets that are already used in state-of-the-art motors and generators and other energy-sector applications represent the next generation, in magnetism's role in energy production. It is well known that electric motors use electrical energy to produce mechanical energy through the interaction of magnetic fields and current-carrying conductors. It is also known that a generator converts mechanical energy into electrical energy. Both devices work because of electromagnetic induction, which is when a voltage is induced by a changing magnetic field. In addition to AC versus DC types, electric motors may be brushed or brushless, may be of various phase (single-phase, two-phase, or three-phase), and may be either air-cooled or liquid-cooled. Electric motors can be used in reverse as generators to recover energy that might otherwise be lost as heat and friction. Brushless RC Motors work on the principle that electromagnets or poles are stationary and permanent magnets are on the spinning portion of the motor. There are two types of Brushless RC motors, in-runners and out-runners. The permanent magnets of in-runner brushless motors are positioned on the inside of the electromagnets. An out-runner brushless motor has the permanent magnets on the outside of the electromagnets. The faster a motor spins, the more efficient it is. In-runner motors turn very fast and are much more efficient than out-runner motors.

An objective of the present invention is to provide an improved design for a power generator using multiple independent rotor and stator assemblies. According to the present invention, a top drive motor runs a generator that has dual magnetic rotors, wherein the whole assembly is mounted on a single stabilizing post. An induction motor can act as an induction generator when it runs with a speed more than a synchronous speed of the magnetic field, wherein, the motor delivers active power and absorbs reactive power for its own magnetic field. According to the present invention, the generator comprises two magnetic rotors, one of which has an in-runner configuration, and the other has an out-runner configuration. The two magnetic rotors, arranged in the two different configurations, generate power that is much greater that the input energy provided to run the top drive motor. Thus, it is an aim of the present invention to have an assembly formed of multiple rotor stator assemblies, wherein a small amount of power provided to a driving motor, runs a generator, and wherein the generator generates a larger magnitude of power, that could be recovered and saved as usable energy.

### BRIEF DESCRIPTION OF THE DRAWINGS

FIG. 1 is a block diagram of the present invention wherein thinner flowlines represent electrical connections between components.

FIG. 2 is a top front perspective view of the present invention.

FIG. 3 is a detail view of section 3 of FIG. 2.

FIG. 4 is a top view of the present invention.

FIG. 5 is a bottom view of the present invention.

FIG. 6 is a side view of the present invention.

FIG. 7 is an exploded top front perspective view of the present invention.

FIG. 8 is a top front perspective view of the present invention with a protective casing.

FIG. 9 is an alternate embodiment of the present invention wherein two generators are mounted on opposing sides of a driving motor on the stabilizing post.

FIG. 10 is a block diagram of the present invention, wherein details of a supporting electrical system are depicted, and wherein thinner flowlines represent electrical connections between components.

### DETAIL DESCRIPTIONS OF THE INVENTION

All illustrations of the drawings are for the purpose of describing selected versions of the present invention and are not intended to limit the scope of the present invention.

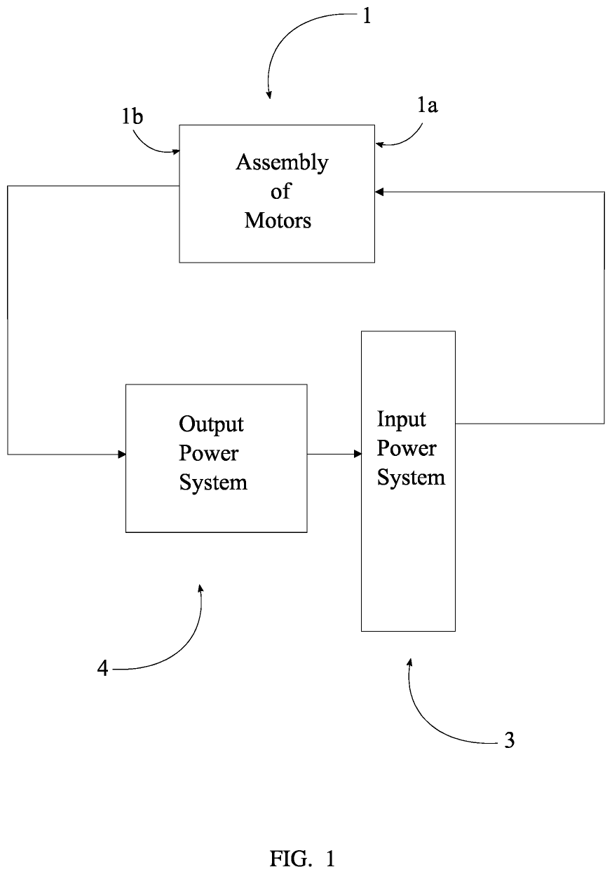

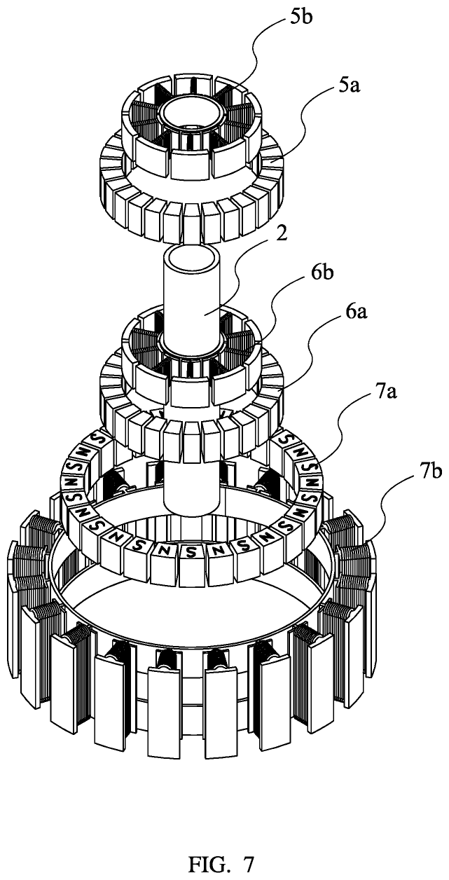

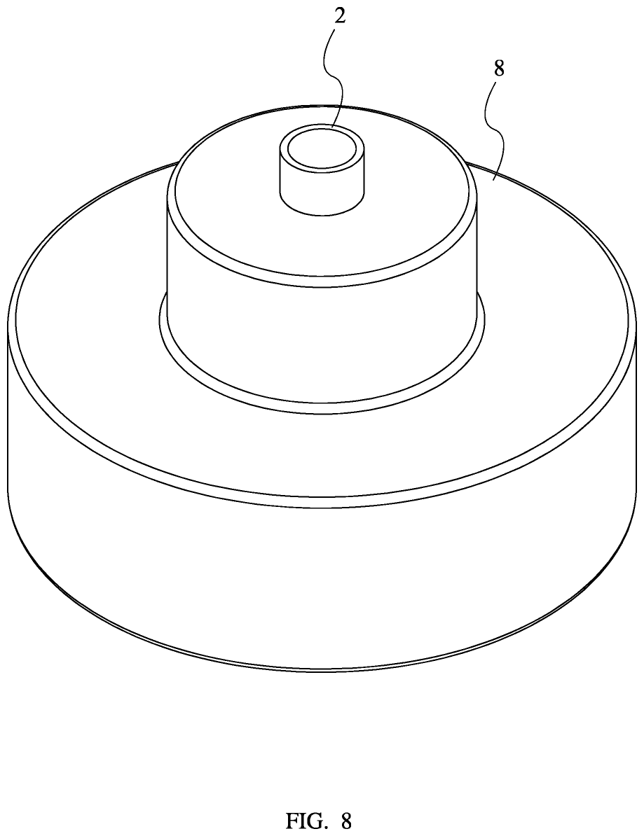

In reference to FIG. 1-10, the present invention may be understood as a power converter. The power converter aims to provide an improved design for a power generator using multiple independent rotor and stator assemblies. According to the present invention, a top drive motor runs a generator that has dual magnetic rotors, wherein the whole assembly is mounted on a single stabilizing post that acts as the stator coil for the top drive motor. An induction motor can act as an induction generator when it runs with a speed more than a synchronous speed of the magnetic field, wherein, the motor delivers active power and absorbs reactive power for its own magnetic field. According to the present invention, the generator comprises two magnetic rotors, one of which has an in-runner configuration, and the other has an out-runner configuration. The two magnetic rotors, arranged in the two different configurations, generates power that is much greater that the input energy provided to run the top drive motor. Thus, it is an aim of the present invention to have an assembly formed of three magnetic rotors, wherein a small amount of power provided to a driving motor, runs a generator that has dual magnetic rotors, and wherein the generator generates a larger magnitude of power, that could be recovered and saved as usable energy.

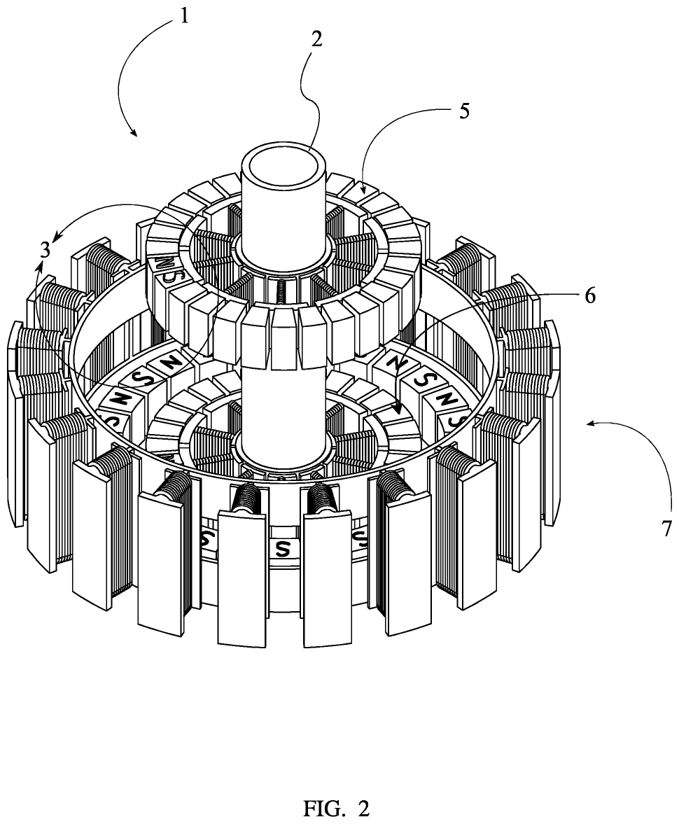

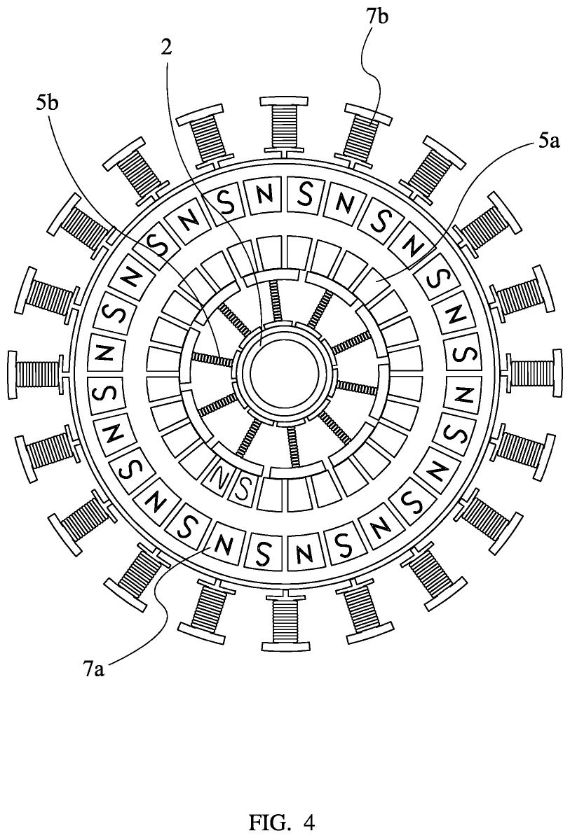

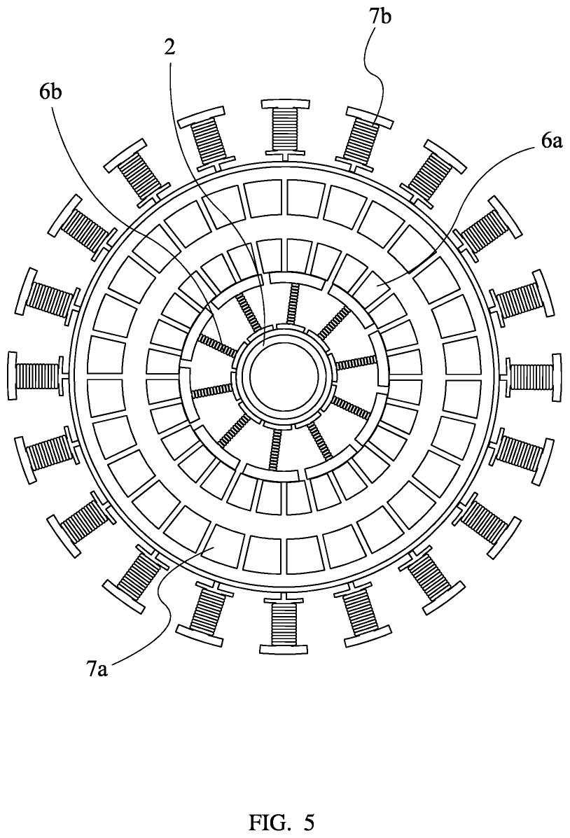

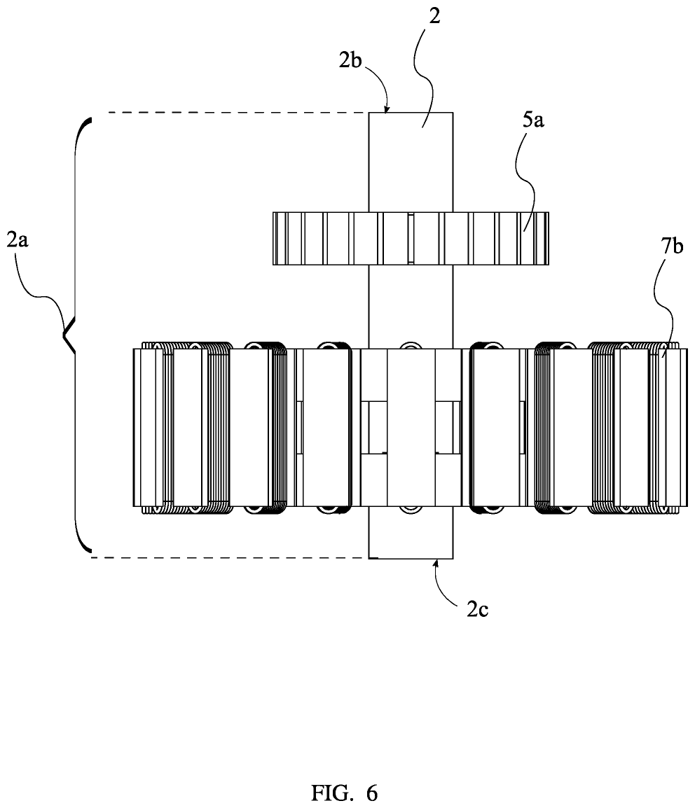

The following description is with reference to FIG. 1 through FIG. 8. As seen in FIG. 1 through FIG. 6, the present invention is a nested rotor power converter comprising an assembly of motors 1, a center rod 2, an input power system 3, and an output power system 4. Preferably, the assembly of motors 1 comprises a first motor 5, a second motor 6 and a third motor 7, wherein the first motor 5 and the second motor 6 are concentrically mounted around the center rod 2. According to a preferred embodiment of the present invention, a drive motor runs a generator that has dual magnetic rotors, wherein the whole assembly is mounted on a single stabilizing post. Accordingly, the first motor 5 together with the second motor 6 act as the generator motor and the third motor 7 acts as the drive motor. The center rod 2 is the single stabilizing post that carries all the electrical connections within the rod as well as act as the supporting structure around which the assembly of motors 1 is mounted. To that end, the center rod 2 is cylindrical and hollow in the middle. As seen in FIG. 2 and FIG. 6, the first motor 5 is laterally offset from the second motor 6 along a length 2a of the center rod 2, and the first motor 5 and the second motor 6 are vertically aligned along the center rod 2. Further, as seen in FIG. 4 and FIG. 5, the third motor 7 is concentrically mounted around the second motor 2. In other words, the third motor 7 encircles the second motor 6. This is so that the third motor 7 may induce electromagnetic rotations on the second motor 6 and the first motor 5, and thus create a generator producing alternating current. According to the preferred embodiment, the first motor 5 and the second motor 6 are outrunner brushless motors, and the third motor 7 is an in-runner brushless motor. This is because two magnetic rotors arranged in two different configurations, generate power that is much greater than the input energy provided to run the drive motor. To accomplish smooth transfer of energies and thus enable the functionality of the present invention, a first terminal end 1a of the assembly of motors 1 is electrically connected to the input power system 3. Further, a second terminal end 1b of the assembly of motors 1 is electrically connected to the output power system 4. Preferably, the input power system 3 comprises a DC battery, and the output power system 4 comprises a power bank. However, the input power system 3 and the output power system 4 may comprise any other specifics, size, brands, components, arrangement of components etc., as long as the intents of the present invention are not altered. Additionally, the input power system 3 and the output power system 4 may comprise any other electrical components and circuitry that are known to one of ordinary skill in the art, as long as the intents of the present invention are not altered. Thus, according to the preferred embodiment, the assembly of motors 1 are operably coupled in between the input power system 3 and the output power system 4, such that the second motor 6 and the first motor 5 absorb reactive power of the third motor 7 and deliver active power to the output power system 4. Active power is the actual power dissipated in a circuit whereas the power which continuously bounces back and forth between source and load is known as reactive power. In other words, reactive power is the power that flows back from a destination toward the grid in an alternating current scenario. Thus, a small amount of power provided to the third motor 7 runs a generator (the first motor 5 and the second motor 6), and the generator generates a larger magnitude of power, that could be recovered and saved as usable energy.

A more detailed description of the assembly of motors 1 follows. As seen in FIG. 2 through FIG. 7, the first motor 5 comprises a first rotor 5a and a first stator 5b, the second motor 6 comprises a second rotor 6a and a second stator 6b, and the third motor 7 comprises a third rotor 7a and a third stator 7b. The first rotor 5a comprises a concentric layer of permanent magnets of alternating polarity. Inside the first rotor 5a, rests the first stator 5b, the first stator 5b comprising copper windings wound around metal pieces, forming the electromagnet of the first motor assembly. In other words, the first stator 5b comprises copper windings wound around a first layer of metal pieces. This form of arrangement where the rotor is set outside the stator is called an out-runner brushless motor. Further down along the center rod 2, is the second rotor stator assembly or second motor 6. In the preferred embodiment, the first motor 5 and second motor 6 are vertically aligned along the center rod 2. Preferably, the second rotor 6a comprises a second concentric layer of permanent magnets that have alternating polarity, and the second stator 6b comprises copper windings wound around a second layer of metal pieces. According to the preferred embodiment, the second motor 6 is also arranged in an out-runner brushless model. Thus, wherein the first motor 5 and the second motor 6 are out-runner brushless motors, the first rotor 5a is positioned concentrically outside the first stator 5b and the second rotor 6a is positioned concentrically outside the second stator 6b.

Continuing with the preferred embodiment, the third rotor 7a comprises a third concentric layer of permanent magnets of alternating polarity. Preferably, the third rotor 7a is formed concentrically outside the second rotor 6a. As seen in FIG. 2, the third stator 7b comprises copper windings wound around a third layer of metal pieces. Thus, the third motor 7 is in an in-runner brushless motor arrangement, wherein the third stator 7b is formed outside the third rotor 7a. As seen in FIG. 4 and FIG. 5, the third stator 7b is the outer most concentric/ring structure of the power converter assembly. In other words, wherein the third motor 7 is an in-runner brushless motor, the third rotor 7a is positioned concentrically outside the second rotor 6a, and the third stator 7b is positioned concentrically outside the third rotor 7a.

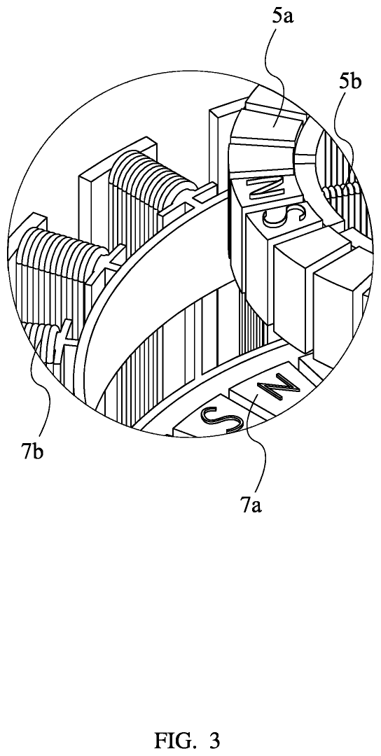

In reference to FIG. 3, a small section of the first rotor 5a (above) and a small section of the third rotor 7a (below) are also visible. As seen in FIG. 1 and FIG. 6, the first motor 5 and the second motor 6 are vertically aligned along the center rod 2, and the first motor 5 and the second motor 6 have similar dimensions. Further, the third in-runner motor has a diameter/circumference greater than that of the first and second motors. This is so that the third motor 7 may be mounted outside the second motor 6 and thereby act as the drive motor. According to the present invention, the third motor 7 is externally connected to necessary circuitry that provides electrical energy to the third motor 7, wherein the third motor 7 runs the second motor 6 and the first motor 5. Accordingly, the second motor 6 and the first motor 5 of the power converter runs with a speed more than the synchronous speed of the magnetic field of the corresponding rotors, and thus act as a generator. To accomplish this, as seen in FIG. 6, the first motor is positioned adjacent a first end 2b of the center rod 2, and the second motor 6 and the third motor 7 are positioned adjacent a second end 2c of the center rod 2.

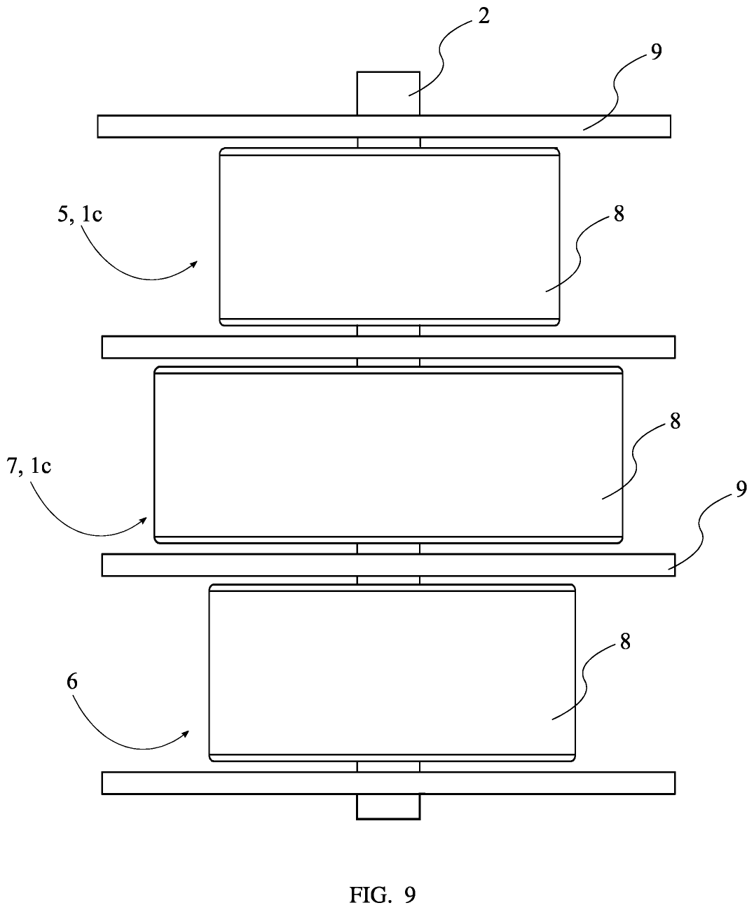

In order to protect the components of the assembly of motors 1, the present invention comprises a protective casing 8. To that end, the protective casing 8 encapsulates the assembly of motors 1, and the center rod 2 traverses normally through the protective casing 8. As seen in FIG. 9, the protective casing 8 comprises a cake shaped covering that covers the assembly of motors 1 conformally. However, the protective casing 8 may comprise any shape, size, and material as long as the intents of the present invention are not altered.

According to a first alternate embodiment of the present invention, and in reference to FIG. 9, the third motor 7 is positioned in between the first motor 5 and the second motor 6. Accordingly, the first motor 5, the second motor 6 and the third motor 7 are concentrically mounted around the center rod 2, wherein the first motor 5, the second motor 6, and the third motor 7 are laterally offset across the length 2a of the center rod 2. In other words, in the first alternate embodiment, the drive motor (in-runner brushless motor) drives the two alternators or generators on either side of the drive motor, along the center rod. In order to house the assembly of motors 1 as a stable structure, the present invention comprises a plurality of stabilizing plates 9. Preferably each of the plurality of stabilizing plates 9 is mounted in between corresponding motors 1c, wherein the corresponding motors 1c are from the assembly of motors 1. In other words, each segment is separated by a stabilizing plate and a ball bearing housing for additional hold and support on the center rod 2. It should be noted that, the plurality of stabilizing plate 9 and ball bearing housing may be formed of any material, size or shape, as long as the intends of the present invention are not limited/altered. Further, any other mounting materials or technology may be employed to house the assembly of motors 1, as long as the objectives of the present invention are fulfilled.

The power converter comprises associated electrical components and external circuitry that enables the smooth functioning, energy transfers and energy storage of the present invention. To that end, the present invention comprises a supporting electrical system 10, wherein the supporting electrical system 10 is connected in between terminal ends (1a and 1b) of the assembly of motors 1. The electrical components of the supporting electrical system 10 may be of any size, specifications, and/or brand, that is known to one of ordinary skill in the art, as long as they do not hinder/alter the intended purpose of the present invention. Examples of such electrical components include, but are not limited to battery banks, boost converters, electronic speed converter (ESC), rectifier, charge controller, relay switch, dump loaders (capacitors), circuit boxes etc.

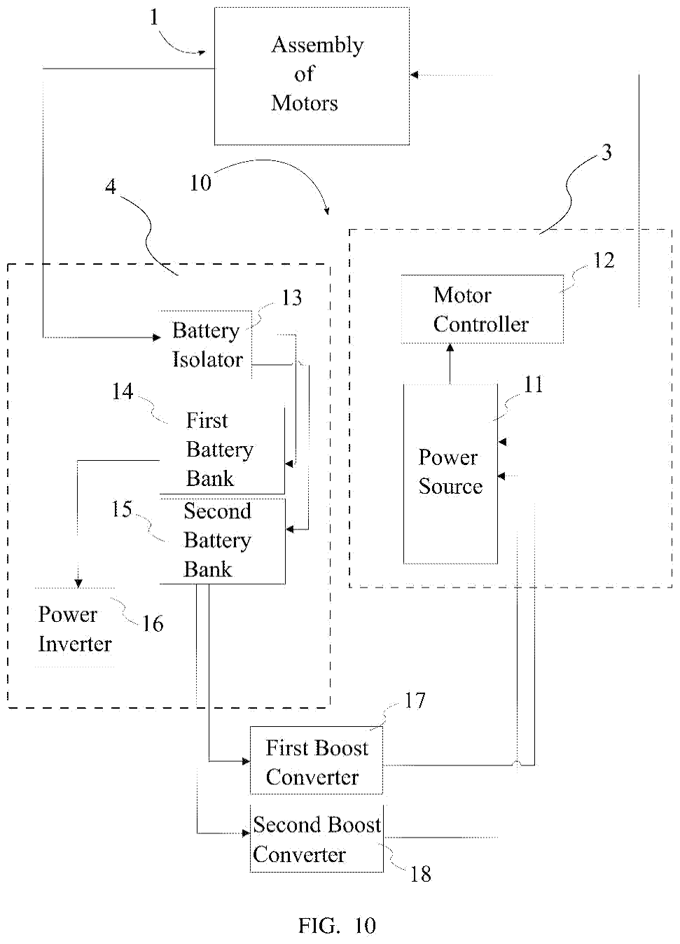

In reference to FIG. 10, a detailed description of the supporting electrical system 10, according to a preferred embodiment of the present invention is depicted. In other words, according to this embodiment, the supporting electrical system 10 follows a specific arrangement of components as described below. Accordingly, as seen in FIG. 10, a power source 11 is connected to the assembly of motors 1 through a motor controller 12. A motor controller is a device or group of devices that can coordinate in a predetermined manner the performance of an electric motor. Preferably, the power source 11 is a 72V (volts) battery, the motor controller 12 is a 72V controller, and they are connected to the main drive motor (third motor 7). On receiving power from the power source 11, the assembly of motors 1 starts rotating. Thus, the first motor 5 and the second motor 6 now become generators that produce alternating current or alternators. Output terminals of the two 12 V alternators (the first motor 5 and the second motor 6) are wired in parallel to a battery isolator 13 or intelligent solenoid, which in turn is connected to two battery banks, namely a first battery bank 14 and a second battery bank 15. A battery isolator is used to separate the DC bus into multiple (isolated) branches and only allow current flow in one direction in each branch. This supports simultaneously charging more than one battery from a single alternator or other power sources without connecting the batteries in parallel. Further, the first battery bank 14 connects to a DC/AC power inverter 16 of 1500 Watts to 2100 Watts, and the second battery bank 15 connects to two boost converters (a first boost converter 17 and a second boost converter 18) that are set to 12 V/40 AH (Amp hours) and boosted to 72 V/10 AH. A boost converter is used to “step-up” an input voltage to some higher level, required by a load. This unique capability is achieved by storing energy in an inductor and releasing it to the load at a higher voltage. More specifically, the first boost converter 17 and the second boost converter 18 are wired in parallel and connected to the main 72V battery pack or input power source. This enables charging of the power source 11 as well. Thus, the present invention is an efficient power converter that enables to store the output energy from the generators for alternate usage, as well as use the excess to replenish lost charge of the input power source 11. Additionally, the center rod 2 has port holes for three phase stator coil wires or generator that are connected to supporting electrical system 10 since three phase generators offer increased reliability for commercial and industrial use by creating three alternating currents that ensures continuous power generation. It should be noted that the present invention may comprise any other components or arrangement of components that are known to one of ordinary skill in the art, as long as the intents of the present invention are fulfilled.

Although the invention has been explained in relation to its preferred embodiment, it is to be understood that many other possible modifications and variations can be made without departing from the spirit and scope of the invention as hereinafter claimed.

What is claimed is:

1. A nested rotor power converter, the power converter comprising:
an assembly of motors;
a center rod;
an input power system;
an output power system;
the assembly of motors comprising a first motor, a second motor and a third motor;
the first motor, the second motor, and the third motor being concentrically mounted around the center rod;
the first motor being laterally offset from the second motor along a length of the center rod;
a first terminal end of the assembly of motors being electrically connected to the input power system;
a second terminal end of the assembly of motors being electrically connected to the output power system; and
the assembly of motors being operably coupled in between the input power system and the output power system, such that the first motor and the second motor absorbs reactive power of the third motor and delivers active power to the output power system.

2. The power converter of claim 1, comprising:
the first motor and the second motor being outrunner brushless motors; and
the third motor being an in-runner brushless motor.

3. The power converter of claim 1, wherein the first motor and the second motor being vertically aligned along the center rod.

4. The power converter of claim 1, comprising:
the first motor comprising a first rotor and a first stator;
the second motor comprising a second rotor and a second stator;
the third motor comprising a third rotor and a third stator;
the first rotor comprising a first concentric layer of permanent magnets of alternating polarity;
the first stator comprising copper windings wound around a first layer of metal pieces;
the second rotor comprising a second concentric layer of permanent magnets of alternating polarity;
the second stator comprising copper windings wound around a second layer of metal pieces;
the third rotor comprising a third concentric layer of permanent magnets of alternating polarity; and
the third stator comprising copper windings wound around a third layer of metal pieces.

5. The power converter of claim 4, comprising
wherein the first motor and the second motor being out-runner brushless motors;
the first rotor being mounted concentrically outside the first stator; and
the second rotor being mounted concentrically outside the second stator.

6. The power converted of claim 4, comprising:
wherein the third motor being an in-runner brushless motor;
the third rotor being positioned concentrically outside the second rotor; and
the third stator being positioned concentrically outside the third rotor.

7. The power converter of claim 1, comprising:
the first motor being mounted adjacent a first end of the center rod; and
the second motor and the third motor being mounted adjacent a second end of the center rod.

8. The power converter of claim 1, comprising:
a protective casing;
the protective casing encapsulating the assembly of motors; and
the center rod traversing normally through the protective casing.

9. The power converted of claim 1, comprising:
a supporting electrical system; and
the supporting electrical system being connected in between terminal ends of the assembly of motors.

10. The power converter of claim 1, comprising:
wherein the third motor is positioned in between the first motor and the second motor: and
the first motor, the second motor, and the third motor being laterally offset along the length of the center rod.

11. The power converter of claim 10, comprising:
a plurality of stabilizing plates;
each of the plurality of stabilizing plates being mounted adjacent a corresponding motor, wherein the corresponding motor is from the assembly of motors; and
the center rod traversing through the plurality of stabilizing plates.

12. A nested rotor power converter, the power converter comprising:
an assembly of motors;
a center rod;
an input power system;
an output power system;
the assembly of motors comprising a first motor, a second motor and a third motor;
the first motor, the second motor, and the third motor being concentrically mounted around the center rod, wherein the first motor and the second motor being outrunner brushless motors;
the first motor being laterally offset from the second motor along a length of the center rod;
the first motor and the second motor being vertically aligned along the center rod;
the third motor being an in-runner brushless motor;
a terminal end of the third motor being electrically connected to the input power system;
a terminal end of the first motor being electrically connected to the output power system; and
the assembly of motors being operably coupled in between the input power system and the output power system, such that the first motor and the second motor absorbs reactive power of the third motor and delivers active power to the output power system.

13. The power converter of claim 12, comprising:
the first motor comprising a first rotor and a first stator;
the second motor comprising a second rotor and a second stator;
the third motor comprising a third rotor and a third stator;
the first rotor comprising a first concentric layer of permanent magnets of alternating polarity;
the first stator comprising copper windings wound around a first layer of metal pieces;
the second rotor comprising a second concentric layer of permanent magnets of alternating polarity;
the second stator comprising copper windings wound around a second layer of metal pieces;
the third rotor comprising a third concentric layer of permanent magnets of alternating polarity; and
the third stator comprising copper windings wound around a third layer of metal pieces.

14. The power converter of claim 13, comprising
the first rotor being mounted concentrically outside the first stator; and
the second rotor being mounted concentrically outside the second stator.
the third rotor being mounted concentrically outside the second rotor; and
the third stator being mounted concentrically outside the third rotor.

15. The power converter of claim 12, comprising:
a protective casing;
a plurality of stabilizing plates;
the protective casing encapsulating a corresponding motor, wherein the corresponding motor is from the assembly of motors;
the center rod traversing normally through the protective casing;
each of the plurality of stabilizing plates being mounted adjacent a corresponding motor, wherein the corresponding motor is from the assembly of motors; and
the center rod traversing through the plurality of stabilizing plates.

16. The power converted of claim 12, comprising:
a supporting electrical system;
the supporting electrical system being connected in between terminal ends of the assembly of motors.

17. The power converter of claim 12, comprising:
wherein the third motor is positioned in between the first motor and the second motor; and
the first motor, the second motor, and the third motor being laterally offset along the length the center rod.

18. A nested rotor power converter, the power converter comprising:
an assembly of motors;
a center rod;
an input power system;
an output power system;
the assembly of motors comprising a first motor, a second motor and a third motor;
the first motor comprising a first rotor and a first stator;
the second motor comprising a second rotor and a second stator;
the third motor comprising a third rotor and a third stator;
the first motor, the second motor, and the third motor being concentrically mounted around the center rod, wherein the first motor and the second motor being outrunner brushless motors;
the first motor being laterally offset from the second motor along a length of the center rod;
the third motor being an in-runner brushless motor;
a terminal end of the third motor being electrically connected to the input power system;
a terminal end of the first motor being electrically connected to the output power system; and
the assembly of motors being operably coupled in between the input power system and the output power system, such that the first motor and the second motor absorbs reactive power of the third motor and delivers active power to the output power system.

19. The power converter of claim 18, comprising
the first rotor being mounted concentrically outside the first stator; and
the second rotor being mounted concentrically outside the second stator.
the third rotor being mounted concentrically outside the second rotor; and
the third stator being mounted concentrically outside the third rotor.

20. The power converter of claim 18, comprising:
wherein the third motor is positioned in between the first motor and the second motor; and
the first motor, the second motor, and the third motor being laterally offset along the length the center rod.
